(19) United States
(12) Patent Application Publication
(10) Pub. No.: US 2025/0163981 A1
(43) Pub. Date: May 22, 2025

(54) MULTI-PISTON DISENGAGEMENT SYSTEM FOR A BRAKING DEVICE OF A MOTOR VEHICLE AND BRAKING DEVICE FOR A TRANSMISSION ASSEMBLY OF A MOTOR VEHICLE WITH THE MULTI-PISTON DISENGAGEMENT SYSTEM

(71) Applicant: Schaeffler Technologies AG & Co. KG, Herzogenaurach (DE)

(72) Inventors: Simon Ortmann, Pulheim (DE); Claudia Seiter, Bühlertal (DE)

(73) Assignee: Schaeffler Technologies AG & Co. KG, Herzogenaurach (DE)

(21) Appl. No.: 18/840,193

(22) PCT Filed: Jan. 27, 2023
(86) PCT No.: PCT/DE2023/100061

§ 371 Date: Aug. 21, 2024

(30) Foreign Application Priority Data
Feb. 25, 2022 (DE) 10 2022 104 555.2

(51) Int. Cl. F16D 65/18; F16D 121/04; F16D 125/06

(52) U.S. Cl. CPC F16D 65/186; F16D 2121/04; F16D 2125/06

(57) ABSTRACT

A multi-piston disengagement system for a vehicle braking device includes an annular housing formed from a main housing and a housing cover, and a plurality of hydraulic actuation assemblies. The annular housing includes a main axis defining an axial direction, a plurality of housing portions, a plurality of pressure chambers, and a flow channel fluidically connecting the plurality of pressure chambers. Each one of the plurality of pressure chambers is arranged in a respective one of the plurality of housing portions and arranged to be filled with a fluid. Each one of the plurality of hydraulic actuation assemblies includes a piston arranged in a respective one of the plurality of pressure chambers and axially movable therein. The piston is arranged to displace in an actuation stroke for introducing an actuation force into the vehicle braking device when a hydraulic pressure is applied to the fluid.

### CROSS-REFERENCE TO RELATED APPLICATIONS

This application is the United States National Phase of PCT Appln. No. PCT/DE2023/100061 filed Jan. 27, 2023, which claims priority to German Application No DE102022104555.2 filed Feb. 25, 2022, the entire disclosures of which are incorporated by reference herein.

### TECHNICAL FIELD

The present disclosure relates to a multi-piston disengagement system for a braking device of a motor vehicle, and to a braking device for a transmission assembly of a motor vehicle having said multi-piston disengagement system.

### BACKGROUND

Piston disengagement systems for actuating clutches or brakes in an electric drive train of a motor vehicle are well known from the prior art. For example, document DE 10 2020 104 771 A1 describes a slave cylinder for a disengagement system of a motor vehicle having a housing which forms a pressure chamber, and having a piston which is arranged to be axially movable in the pressure chamber. To actuate a clutch, the piston can introduce an actuation force into the clutch.

### SUMMARY

The present disclosure provides a multi-piston disengagement system which is designed to actuate a brake device, wherein the brake device is a component of a braking device for a transmission assembly of a motor vehicle. For example, the brake device is a wet-running multi-disc service brake, which can be arranged or is arranged within a wet space of an electric motor vehicle or hybrid motor vehicle. The motor vehicle may be an electric motor vehicle, e.g., an electrically or hybrid-powered car or commercial motor vehicle.

The multi-piston disengagement system includes an annular housing. The annular housing has a main axis that defines an axial direction. The annular housing is arranged to be concentric to the main axis, for example.

The annular housing includes a plurality of housing portions and a plurality of pressure chambers that can be filled and/or are filled with a fluid, e.g., a hydraulic fluid. A pressure chamber is arranged in each housing portion, e.g., is integrated into the housing portion and/or formed therein.

The annular housing has one e.g., exactly one, flow channel. The pressure chambers are fluidically connected to each other by means of the flow channel. The annular housing may have a fluid inlet through which the fluid can be introduced into the flow channel and from there can flow into the pressure chambers.

The multi-piston disengagement system includes multiple hydraulic actuation assemblies having a plurality of piston units. For example, the multi-piston disengagement system includes four, six or eight actuation assemblies and/or piston units. The actuation assemblies may be arranged to be spaced apart from one another at regular intervals in the circumferential direction around the annular housing. Thus, the annular housing and the resulting annularly arranged multi-piston disengagement systems can be integrated into the brake assembly in a space-saving manner.

Each actuation assembly is associated with exactly one housing portion of the annular housing. Each actuation assembly includes exactly one piston unit with one piston. The piston is arranged to be axially movable in the pressure chamber. When hydraulic pressure is applied, the piston can carry out an actuation stroke to introduce an actuation force into the brake device. For example, during and/or after the carrying out of the actuation stroke, the piston introduces a compressive force as an actuation force into a multiple disc pack of the brake device, wherein the multiple disc pack includes a plurality of friction discs. The actuation force causes the friction plates to be pressed together in a frictional manner to generate a braking force.

Each actuation assembly may include a spring assembly which includes a return device. The return device may be designed to return the piston in an axially opposite direction. For example, the piston performs a return stroke when it is returned by means of the return device.

According to the disclosure, the annular housing is designed in two parts in the axial direction. It includes a main housing as a first part and a housing cover as a second part. The main housing and the housing cover may be annular and/or formed as a closed ring. For example, the main housing and the housing cover can be arranged axially on top of one another and/or one behind the other, e.g., assembled together.

In an example embodiment, the main housing includes the flow channel. The flow channel may be arranged in or on the main housing, e.g., introduced into the main housing, e.g., by machining. Optionally, the main housing includes the housing portions. The housing portions may be arranged in or on the main housing, e.g., the housing portions are formed by the main housing, e.g., integrated therein in one piece and/or in one material.

A further embodiment provides that the flow channel is arranged in a separating plane of the main housing and the housing cover. The arrangement of the flow channel in the separating plane is easily accessible and the flow channel can therefore be introduced into the main housing, and, for example, manufactured, at low cost. For example, a complex and costly production of the flow channel by means of radial bores that are introduced into a one-piece annular housing and that are closed at the ends by means of closure elements for sealing can be avoided.

In a possible constructive implementation, the flow channel is annular and/or designed as a circumferential, closed ring. The flow channel may be arranged to be concentric and/or coaxial to the main axis. The annular design of the flow channel need not be closed using closure elements.

A further possible constructive implementation provides for a plurality of axial bores which are arranged in the main housing, e.g., are introduced thereinto. The axial bores may fluidically connect the flow channel with the pressure chambers in the housing portions of the main housing. For example, at least one axial bore runs between the flow channel and one of the pressure chambers. For example, the axial bores are drilled through the flow channel and open into the pressure chambers.

In an example implementation, the multi-piston disengagement system includes at least one channel seal, which is designed and/or arranged to seal the flow channel. Optionally, the at least one channel seal is arranged in or on the main housing. Alternatively, the at least one channel seal is arranged on the housing cover. For example, the at least one channel seal is designed as at least one O-ring, e.g., as a first and a second O-ring. However, it is also possible that at least one channel seal is arranged between the main housing and the housing cover. In this arrangement, the at least one channel seal may be designed as, for example, an annular sealing plate.

A further implementation provides that the housing cover has at least one annular groove for the at least one O-ring, e.g., an inner annular groove and an outer annular groove for the first and second O-ring. Alternatively, the main housing may have at least one annular groove, e.g., the inner annular groove and the outer annular groove. Here, the housing cover need not be machined to create at least one annular groove. The housing cover can therefore be designed, for example, as a cost-effective sheet metal blank. The at least one O-ring may be arranged in the at least one sealing groove, for example.

For example, the at least one annular groove is arranged to be concentric and/or coaxial to the main axis and/or to the annular flow channel. The outer annular groove may extend radially outside the flow channel, wherein it radially surrounds the flow channel. The inner annular groove may extend radially within the flow channel, wherein it radially surrounds the inner annular groove.

If the at least one channel seal is designed as the at least one sealing plate, this may be arranged in the separating plane, e.g., between the main housing and the housing cover. In the form of the annular sealing plate, this may be arranged to be coaxial and/or concentric to the main axis and/or to the main housing and/or to the housing cover.

In a further embodiment, the main housing and the housing cover are connected to one another in a form-fitting and/or force-fitting manner. For example, the main housing and the housing cover are screwed together. This allows at least one channel seal to be secured in a form-fitting manner. Furthermore, the hydraulic pressure in the pressure chambers can be created and maintained.

In a further embodiment, each actuation assembly includes a retaining plate. The retaining plate may be placed in the axial direction on the housing portion of the respective actuation assembly. In particular, the retaining plate may be connected to the housing portion in a force-fitting and/or form-fitting manner, for example by being screwed thereto. In a possible constructive implementation, the spring assembly includes a spring sheet, a spring plate, and a spiral spring. The spring plate may be connected to the spring sheet in a form-fitting and/or force-fitting manner. The spiral spring may be arranged between the spring plate and the retaining plate. For example, the spiral spring is supported in the axial direction on the retaining plate and in the opposite direction on the spring plate.

In a further possible constructive implementation, the spring assembly is operatively connected to the piston unit so that the piston unit entrains the spring assembly when carrying out the actuation stroke and the return stroke. For example, the piston is connected to the spring sheet in a form-fitting and/or force-fitting manner. The piston may press against the spring plate when it carries out the actuation stroke. As a result, the spring sheet and the spring plate attached thereto are moved in the axial direction against the preloading of the spiral spring. When the hydraulic pressure on the piston is released, the piston is returned by the preloading of the coil spring. For example, the spiral spring serves as a return device.

A possible implementation provides that the multi-piston disengagement system includes a force distribution device. The force distribution device is designed to distribute the actuation force introduced into the brake device, e.g., in the circumferential direction around the annular housing.

The friction discs of the multiple disc pack may be subjected to the actuation force evenly in relation to their surface area to avoid so-called hotspots, e.g., to avoid partial overloading of linings and friction surfaces of the friction discs and an associated underloading of other points. The force distribution device allows the actuation force to be distributed across several locations on the friction discs, thus preventing the formation of such hotspots.

In an example embodiment, the force distribution device is designed to introduce the actuation force into the brake device in a plurality of force introduction regions. The force distribution device may include the force introduction regions.

In a further embodiment, the number of force introduction regions is a multiple, e.g., a double or a triple, of a number of pistons of the multi-piston disengagement system. For example, the number of force introduction regions when applying hydraulic pressure to the pistons up to a certain limit pressure is twice the number of existing pistons. For example, the number of force introduction regions may be three times the number of pistons present when the hydraulic pressurization of the pistons exceeds the limit pressure.

A preferred structural implementation provides that the force distribution device includes a force distribution ring. The force distribution ring may be arranged to be coaxial and/or concentric to the annular housing in relation to the main axis. The force introduction regions may be arranged on the force distribution ring, e.g., on an upper side of the force distribution ring pointing in the axial direction.

A further embodiment provides that the force distribution device carries out the actuation stroke together with the pistons. For example, the force distribution device may be arranged directly in the axial direction in front of the piston. The force distribution device may be thereby transferred into a contact position with the brake device when the pistons carry out the actuation stroke. For example, during the forward stroke, the pistons may press against the force distribution device and move it into the contact position. For example, the actuation force of the pistons may be introduced into the brake device by means of the force distribution device when the force distribution device is arranged in the contact position. Alternatively or optionally in addition, the force distribution device may be operatively connected to the pistons for transferring to the contact position and for transmitting the actuation force.

A possible implementation provides that several force introduction regions of the force distribution device are spatially and functionally associated with each piston unit. Each piston unit may be associated with three force introduction regions. This means, for example, that the force introduction regions are arranged in the axial direction in front of the respective spatially associated piston unit so that they can multiply, e.g., double or triple, the actuation force of the respective piston.

In a possible structural embodiment, the force introduction regions are formed by teeth. The teeth on the force distribution ring may be arranged to be spaced apart from one another. For example, the teeth may protrude from the top of the force distribution ring in the axial direction.

An example structural embodiment provides that some teeth have a first height and the other teeth have a second height, and the first height differs from the second height. The first height may be greater than the second height. For example, some teeth are higher than the other teeth.

In a possible implementation, several teeth are spatially and functionally associated with each piston unit. For example, each unit may be spatially and functionally associated with a total of three teeth, with one of these teeth being less high than the other two teeth. Optionally, the tooth with the second, lower height is arranged immediately in front of the piston in the axial direction. Two teeth with the first, greater height may be arranged at a distance on either side of the tooth with the second height. The force distribution device may have a marking by means of which it can be correctly positioned relative to the actuation assembly, e.g., to the piston, as described above.

Due to the spatial and functional association of the teeth to the respective piston, the actuation force can be distributed and harmonized, and it can be distributed to the two teeth or to all three teeth depending on the pressure when hydraulic pressure is applied. For example, the actuation force may be distributed across the three teeth and thus harmonized when the application of a hydraulic pressure to the pistons exceeds the limit pressure.

In an example embodiment, the force distribution device has centering sections, by means of which the force distribution device can be arranged to be concentric relative to the annular housing. The centering sections may be arranged to be spaced apart from one another in the circumferential direction on the force distribution ring, protruding radially therefrom. For example, the centering sections are designed as toothing areas for engaging with the corresponding toothing of a housing, brake assembly, and/or a gearbox. For example, the housing may surround the wet space or may be arranged in the wet space.

The present disclosure also provides a braking system for a motor vehicle with the multi-piston disengagement system according to the previous description. The braking device includes a brake device for generating a braking force. The brake device may be designed according to the above description. For example, the brake device may include the multiple disc pack, which may be arranged to be coaxial and/or concentric to the main axis. The friction plates of the multiple disc pack are inner plates, which are arranged to rotate, for example, and outer plates, which are arranged to be rotationally fixed, for example. The inner discs may be carried by a rotatable inner disc carrier, for example. The friction plates may be arranged and/or designed to be movable in the axial direction and in the axial opposite direction, e.g., to be displaceable relative to one another.

In an example embodiment, when arranged in the contact position, the force distribution device is arranged in contact with the brake device in some or all force introduction regions depending on a pressure from application of a hydraulic pressure to the pistons. Two force introduction regions, e.g., the two teeth with the first, greater height, may contact the brake device when the application of a hydraulic pressure to the pistons takes place with a pressure until the limit pressure is reached. In this case, the actuation force is distributed over the two teeth with the first height and transmitted to the brake device. If the limit pressure is exceeded when the hydraulic pressure is applied to the pistons, the pistons move further and press harder against the force distribution device. This means that the tooth with the second, lower height also contacts the brake device. In this case, the actuation force is distributed across the three teeth of each actuation assembly and transferred to the brake device.

The present disclosure also provides a transmission assembly. The transmission assembly may include a gearbox housing, a gearbox, e.g., a planetary gear, and the braking device according to the previous description. The gearbox and the braking device may be accommodated in the gearbox housing. The braking device, e.g., the brake device, may be arranged in the gearbox housing in such a way that it radially surrounds the gearbox relative to the main axis.

In one possible embodiment, the outer discs have an external toothing with which they positively engage with a matching toothing in the gearbox housing, so that they are secured against rotation and so that they are movable in the axial direction and in the axial opposite direction. The inner plates may have an internal toothing with which they can mesh with a suitable toothing of at least one component of the gearbox.

### BRIEF DESCRIPTION OF THE DRAWINGS

Further features, advantages and effects of the disclosure arise from the following description of exemplary embodiments. In the drawings:

FIG. 1 shows a perspective plan view in an axial direction of a multi-piston disengagement system for actuating a brake device of a motor vehicle having several hydraulic actuation assemblies;

FIG. 2 shows a perspective top view in an axial opposite direction of the multi-piston disengagement system;

FIG. 3 shows a section through a housing portion of an annular housing of the multi-piston disengagement system and through an actuation assembly of the multi-piston disengagement system;

FIG. 4 shows a main housing of the annular housing of the multi-piston disengagement system;

FIG. 5 shows a perspective cross-section of the annular housing through the housing portion and through the actuation assembly; and

FIG. 6 shows a cross-section of the annular housing through the housing portion and through the actuation assembly.

### DETAILED DESCRIPTION

Corresponding or identical parts are designated with the same reference symbols in the figures.

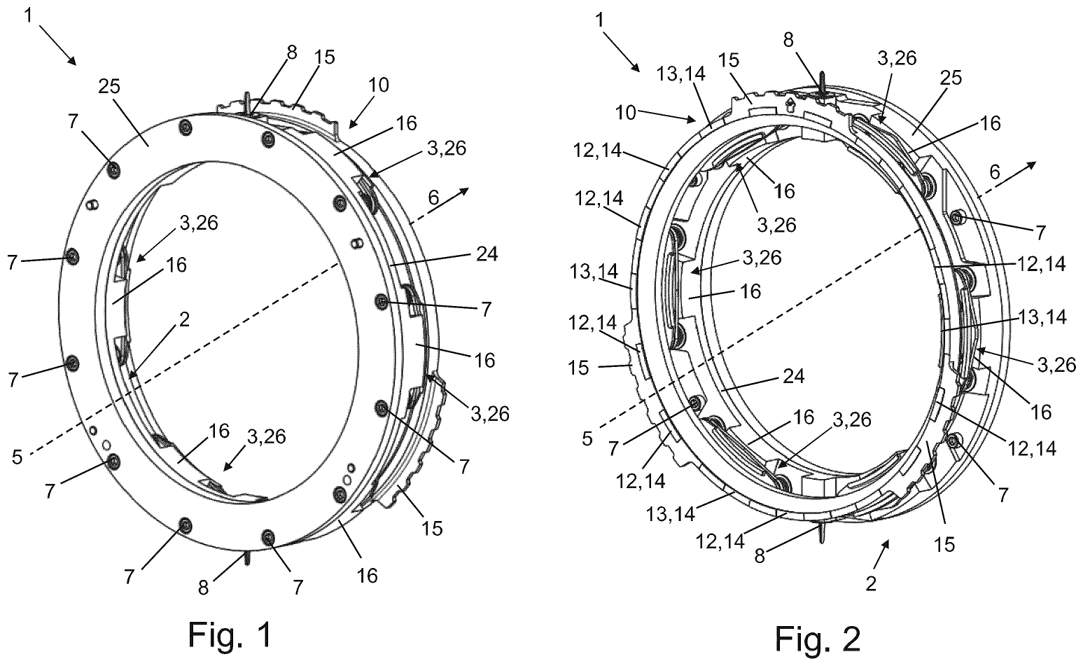

FIG. 1 shows a perspective plan view in an axial direction 6 of a multi-piston disengagement system 1. FIG. 2 shows a perspective top view of the multi-piston disengagement system 1 in an axial opposite direction.

The multi-piston disengagement system 1 can form part of a braking device for a transmission assembly. The braking device includes a brake device which is designed as a wet-running friction disc brake with a multiple disc pack comprising a plurality of friction discs. The multi-piston disengagement system 1 is designed as an activator device for the brake device. It can activate the brake device by transmitting an actuation force to generate a braking force.

The braking device can form a component of a transmission assembly with a gearbox housing filled with a wet space fluid and with a gearbox, e.g., with a planetary gearbox. It can be arranged together with the gearbox in the gearbox housing and can brake there by means of the braking force of at least one component of the gearbox. The gearbox and the braking device can be arranged to be concentric and/or coaxial with respect to a main axis 5 of the multi-piston disengagement system 1, wherein the braking device radially surrounds the gearbox.

The multi-piston disengagement system includes an annular housing 2. The annular housing 2 has a main axis 5 which defines an axial direction 6. The annular housing 2 is formed in two parts in the axial direction 6. It is formed by a main housing 24 and a housing cover 25. The main housing 24 and the housing cover 25 are arranged on top of one another in the axial direction 6 and are screwed together by means of a plurality of housing screws 7.

The main housing 24 has several, for example six, housing portions 16. The housing portions 16 are arranged at regular intervals from one another in the direction of rotation of the main housing 24 around the main axis 5.

The multi-piston disengagement system 1 has several, for example six, hydraulic actuation assemblies 3. Each actuation assembly 3 is associated with exactly one housing portion 16 and is accommodated in sections therein.

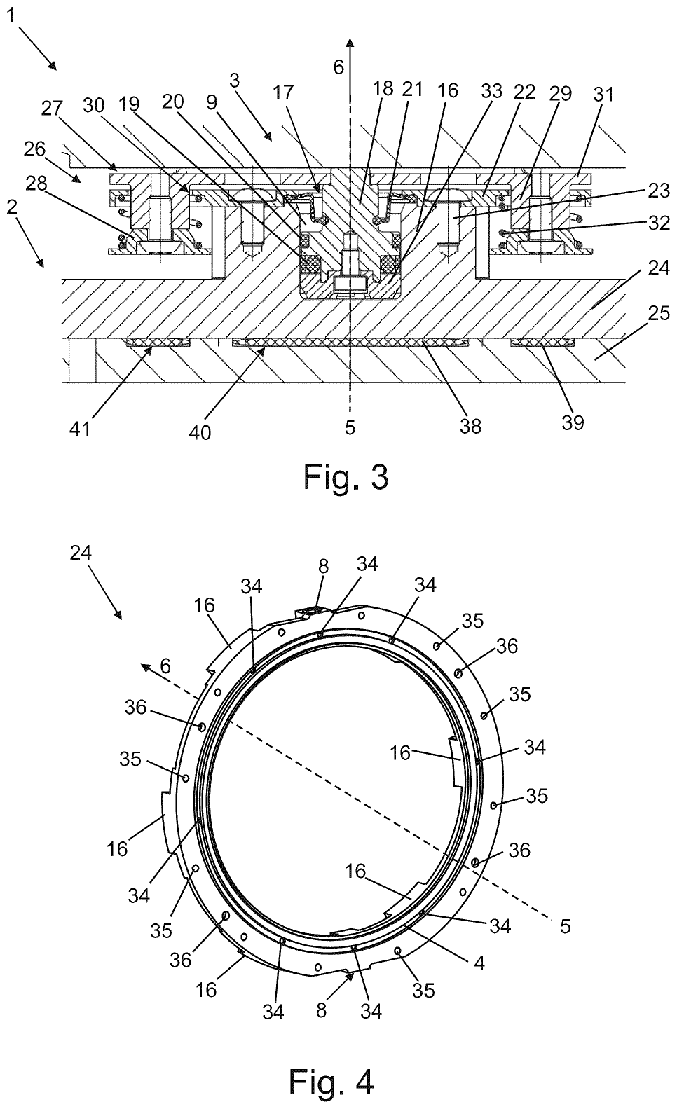

The main housing 24 has several pressure chambers 9 (see FIG. 3). A pressure chamber 9 is formed in each of the housing portions 16 and is associated with the respective actuation assembly 3. The pressure chambers 9 are fluidically connected to one another by a flow channel 4 (see FIGS. 4 to 6), so that they can be filled with a fluid, e.g., a hydraulic fluid, which is different from the fluid of the wet chamber.

FIG. 3 shows a sectional view through the annular housing 2 with the main housing 24 and with the housing cover 25, wherein a cut line runs through a housing portion 16 and through an actuation assembly 3 associated with the housing portion 16.

The actuation assembly 1 includes a piston unit 17. The piston unit 17 has a piston 18. A guide body 33 is screwed to the piston 18. The piston 18 and the guide body 33 are arranged together in the pressure chamber 9 so as to be axially movable. During the axial movement, the guide body 33 guides the piston 18.

The actuation assembly 1 includes a first sealing device 19, a second sealing device 20, and a third sealing device 21. The first sealing device 19 and the second sealing device 20 are designed as O-rings and are arranged on the piston 18 in an immovable manner. They seal the piston 18 against the pressure chamber 9. The first sealing device 19 also functions as a sliding band, which facilitates the sliding of the piston 18 during axial movement. The third sealing device 21 is an axial-translational seal which seals the pressure chamber 9 from the wet space of the gearbox housing.

The actuation assembly 3 includes a retaining plate 22 which is arranged in the axial direction 6 on the housing portion 16 and is screwed thereto by means of two screws 23. When hydraulic pressure is applied by means of the fluid introduced into the pressure chamber 9, the piston 4 can carry out an actuation stroke relative to the housing portion 16 and to the retaining plate 22 attached thereto. The actuation stroke transfers piston 18 to an actuation position in which the brake device is actuated.

The actuation assembly 3 has a spring assembly 26. The spring assembly 26 includes a spring sheet 27 and two spring plates 28. The spring sheet 27 includes a surface section 31 and two axis sections 29 which protrude from the surface section 31 in an axially opposite direction. The surface section 31 is arranged in the axial direction 6 in front of the retaining plate 22, extending parallel to the latter. The retaining plate 22 has two recesses 30 through which the axis sections 29 protrude in the opposite axial direction. The spring plates 28 are container-shaped and are attached at the ends to the axis sections 29 via a screw connection.

The spring assembly 26 has two spiral springs 32. The spiral springs 32 are arranged on the axis sections 29 between the retaining plate 22 and the spring plates 28. The spiral springs 32 are supported with one axial end on the retaining plate 22 and with the other end on the spring plate 28.

The piston 18 is connected to the surface section 31 of the spring sheet 27 in a form-fitting and/or force-fitting manner. During the actuation stroke of the piston 18, the spring sheet 27 is moved together with the spring plates 28 in the axial direction 6 against a preloading of the spiral springs 32. The spiral springs 32 act as return devices which return the piston 18 in the opposite axial direction when the hydraulic pressure decreases.

FIG. 4 shows the main housing 24 of the annular housing 2 in a perspective top view in the axial direction 6. The main housing 24 has the flow channel 4, by means of which the pressure chambers 9 in the housing portions 16 are fluidically connected. The flow channel 4 is designed as a one-piece, closed ring which is arranged to be coaxial and/or concentric to the main axis 5. The flow channel 4 is introduced into the main housing 24 by machining in a separating plane between the main housing 24 and the housing cover 25 (see FIG. 3). Due to the arrangement of the flow channel 4 in the separating plane, it can be manufactured easily and cost-effectively.

The main housing 24 has two fluid inlets 8 through which the fluid can be introduced into or drained from the flow channel 4 and through which the flow channel 4 and the pressure chambers 9 can be vented.

The main housing 24 has several, e.g., six, axial bores 34 which run through the flow channel 4. The axial bores 34 open into the pressure chambers 9 of the respective housing portions 16 and into the fluid inlets 8. The pressure chambers 9 and the fluid inlets 8 are fluidically connected to the flow channel 4 via the axial bores 34. The main housing 24 has, radially outside the flow channel 4, further bores 35 for the housing screws 7 (see FIGS. 1 and 2) and additional bores 36 for fastening to the gearbox housing when the multi-piston disengagement system 1 is integrated in the braking device.

Referring to FIG. 3, the multi-piston disengagement system 1 has at least one channel seal for sealing the flow channel 4. The at least one channel seal is formed by a first O-ring 38 and a second O-ring 39. The housing cover 25 has an inner annular groove 40 and an outer annular groove 41, wherein the inner annular groove 40 is arranged radially inside the outer annular groove 41. The first O-ring 38 is arranged in the inner ring groove 40 and the second O-ring 39 is arranged in the outer ring groove 41.

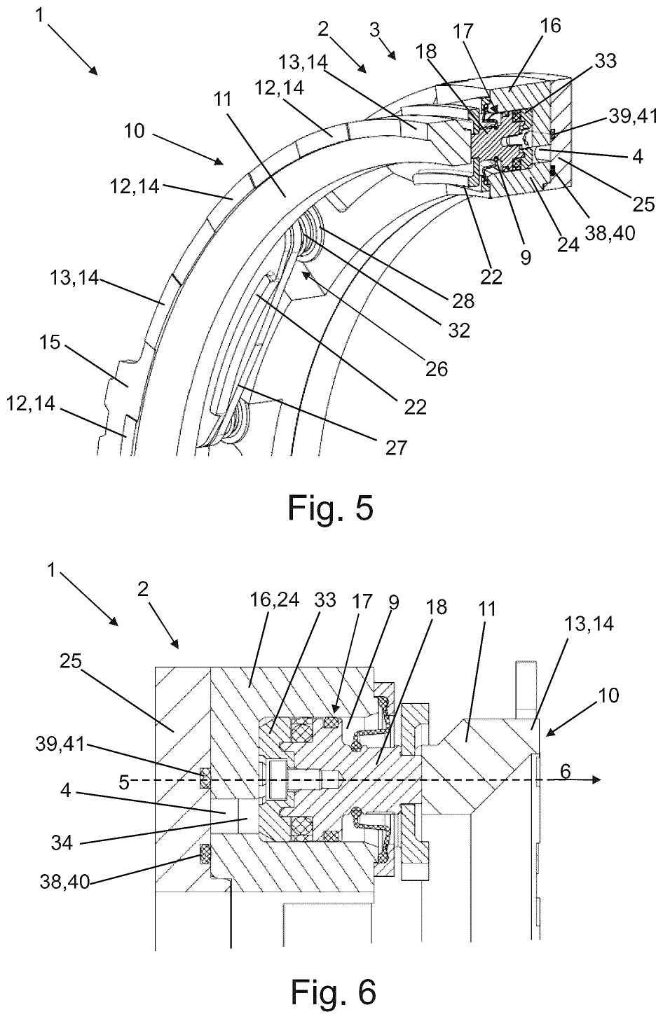

FIG. 5 shows a perspective cross-section of the annular housing 2 through the pressure chamber 9 of the housing portion 16 and through the associated actuation assembly 3. FIG. 6 shows a cross-section of the annular housing 2 through the housing portion 16 and the piston unit 17.

The flow channel 4 is arranged radially between the inner annular groove 40 and the first O-ring 38 arranged therein and the outer annular groove 41 and the second O-ring 39 arranged therein. The O-rings 38, 39 are secured in their sealing position by the housing cover 25 which is screwed to the main housing 24. The fluid in the flow channel 4 cannot escape therefrom. The hydraulic pressure in the pressure chambers 9 for application of a hydraulic pressure to the pistons 18 can be maintained.

Referring to FIGS. 1, 2, 5 and 6, the multi-piston disengagement system 1 includes a force distribution device 10, by means of which an actuation force of the pistons 18 of the multi-piston disengagement system 1 can be divided and thus harmonized depending on the hydraulic pressure.

The force distribution device 10 is located in axial direction 6 immediately in front of the piston 18. It includes a force distribution ring 11 and several force introduction regions 14 arranged thereon. The force distribution ring 11 is arranged to be concentric and/or coaxial to the annular housing 2 with respect to the main axis 5. The number of force introduction regions 14 is a multiple of the number of pistons 18 present in the multi-piston disengagement system 1. During the actuation stroke of the pistons 18, these latter press against the force distribution ring 11, so that the force distribution device 10 is moved together with the pistons 18 in the axial direction 6 and carries out the actuation stroke.

If the multi-piston disengagement system 1 is integrated into the braking device, the force introduction areas 14 can press against the multiple disc pack of the brake device in a contact position of the force distribution device 10 and thereby introduce the actuation force of the piston 18 thereinto. The friction plates of the multiple disc pack are placed together in a frictional fit by the introduction of the actuating force, which allows a braking force to be generated to brake at least one component of the gearbox.

The force introduction regions 14 are designed as teeth 12 with a first height and as teeth 13 with a second height. The first height is greater than the second height. There are a plurality of, e.g., a total of six teeth 13 with the second height and a plurality of, e.g., a total of twelve teeth 12 with the first height. The teeth 12 and 13 are spaced apart in the direction of rotation around the main axis 5 on an upper side of the force distribution ring 11 directed in the axial direction 6 and protrude from it.

The force distribution device 10 has a plurality of, e.g., three, centering sections 15, by means of which the force distribution device 10 can be arranged to be coaxial and/or concentric to the main axis 5 and/or to the annular housing 2. The centering sections 15 are arranged to be spaced apart from one another in the circumferential direction on the force distribution ring 11 and protrude radially therefrom. The centering sections 15 are designed as toothed areas by means of which the force distribution device 10 can engage in corresponding toothings of the gearbox housing when the multi-piston brake system is integrated in the brake assembly and this is arranged in the gearbox housing. During the engagement, the force distribution device 10 is movable in the axial direction 6 and secured against rotation about the main axis 5.

The force distribution ring 11 is arranged and aligned relative to the annular housing 2 such that each piston unit 3 is associated with a total of three teeth 12, 13. In detail, each piston unit 3 is associated with exactly two teeth 12 with the first, greater height and exactly one tooth 13 with the second, smaller height. The tooth 13 with the second height is arranged in the axial direction 6 directly in front of the piston 18. The other two teeth 12 with the first height are arranged at a distance from the tooth 13 with the second height. A marking, not shown, e.g., in the form of an arrow, is arranged on the force distribution ring 11, which facilitates and ensures the positioning of the force distribution ring 11 and the teeth 12, 13 relative to the annular housing 2 and the piston units 3, as previously described.

The distribution of the actuation force to the teeth 12, 13 acting as the force introduction regions 14 depends on a level of pressure for application of a hydraulic pressure to the piston 18. Up to a defined limit pressure, only the two teeth 12 associated with an actuation assembly 3 are pressed against the plate pack with the first, greater height, so that they transmit the actuation force proportionately. As a result, the actuation force transmitted by the piston 18 can be distributed between the two teeth 12 with the first height. If the limit pressure is exceeded, the piston 18 is moved further in the axial direction 6 so that it presses more strongly against the force transmission device 10. As a result, the tooth 13, which is associated with actuation assembly 3, is pressed against the multiple disc pack with the second, lower height, so that it also transmits the actuation force proportionately. In this case, the actuation force transmitted by the piston 18 is divided between all three teeth 12, 13. The division and resulting harmonization of the actuation force is advantageous in that the actuating force can be applied evenly to a surface of the friction plates and partial overloading of linings and friction surfaces of the friction flaps and the associated underloading of other areas of the friction discs can be avoided.

### REFERENCE NUMERALS

1 Multi-piston disengagement system
2 Annular housing
3 Actuation assembly
4 Flow channel
5 Main axis
6 Axial direction
7 Housing screws
8 Fluid inlets
9 Pressure chambers
10 Force distribution device
11 Force distribution ring
12 Teeth with first height
13 Teeth with second height
14 Force introduction regions
15 Centering section
16 Housing portion
17 Piston unit
18 Piston
19 First sealing device
20 Second sealing device
21 Third sealing device
22 Retaining plate
23 Screws
24 Main housing
25 Housing cover
26 Spring assembly
27 Spring sheet
28 Spring plate
29 Axis section
30 Recesses
31 Surface section
32 Spiral spring
33 Guide bodies
34 Axial bores
35 Additional boreholes
36 Additional boreholes
38 First O-ring
39 Second O-ring
40 Inner annular groove
41 Outer annular groove

1. A multi-piston disengagement system for a braking device of a motor vehicle,
having an annular housing, the annular housing comprising a main axis, the main axis defining an axial direction,
the annular housing comprising a plurality of housing portions, a plurality of pressure chambers that can be filled or are filled with a fluid and a flow channel, a one of the plurality of pressure chambers being arranged in each housing portion, the pressure chambers being fluidically connected to one another by means of the flow channel,
comprising a plurality of hydraulic actuation assemblies, a one of the plurality of housing portions being associated with each actuation assembly,
each actuation assembly comprising a piston unit having a piston, the piston being arranged in the pressure chamber so as to be movable in the axial direction and, upon application of a hydraulic pressure, being able to carry out an actuation stroke for introducing an actuation force into the brake device,
wherein
the annular housing is formed in two parts in the axial direction with a main housing and a housing cover.

2. The multi-piston disengagement system according to claim 1, wherein the housing portions and the flow channel are arranged in or on the main housing.

3. The multi-piston disengagement system according to claim 1, wherein the flow channel is arranged in a separating plane of the main housing and the housing cover.

4. The multi-piston disengagement system according to claim 1, wherein the flow channel is annular and is arranged to be concentric or coaxial to the main axis.

5. The multi-piston disengagement system according to claim 1, wherein the main housing comprises a plurality of axial bores, wherein the axial bores fluidically connect the flow channel to the pressure chambers.

6. The multi-piston disengagement system according to claim 1, wherein the multi-piston disengagement system comprises at least one channel seal for sealing the flow channel, wherein the at least one channel seal is at least one O-ring or at least one sealing plate.

7. The multi-piston disengagement system according to claim 6, wherein the main housing or the housing cover comprises at least one annular groove concentric or coaxial with the main axis, wherein the at least one O-ring is arranged in the at least one annular groove.

8. The multi-piston disengagement system according to claim 6, wherein the at least one sealing plate is arranged between the main housing and the housing cover.

9. The multi-piston disengagement system according to claim 1, wherein the main housing and the housing cover are connected to one another in a form-fitting or force-fitting manner.

10. A braking device for a transmission assembly of a motor vehicle having a brake device and having the multi-piston disengagement system according to claim 1, wherein the multi-piston disengagement system forms an activator device for actuating the brake device.

11. A multi-piston disengagement system for a vehicle braking device, comprising:
an annular housing formed from a main housing and a housing cover, the annular housing comprising:
a main axis defining an axial direction;
a plurality of housing portions;
a plurality of pressure chambers, each one arranged in a respective one of the plurality of housing portions and arranged to be filled with a fluid; and
a flow channel fluidically connecting the plurality of pressure chambers;
a plurality of hydraulic actuation assemblies, each comprising a piston:
arranged in a respective one of the plurality of pressure chambers and axially movable therein; and
arranged to displace in an actuation stroke for introducing an actuation force into the vehicle braking device when a hydraulic pressure is applied to the fluid.

12. The multi-piston disengagement system of claim 11, wherein the plurality of housing portions and the flow channel are arranged in or on the main housing.

13. The multi-piston disengagement system of claim 12 further comprising a separating plane arranged between the main housing and the housing cover, wherein the flow channel is arranged in the separating plane.

14. The multi-piston disengagement system of claim 11, wherein the flow channel is annular and arranged concentric or coaxial to the main axis.

15. The multi-piston disengagement system of claim 11, wherein:
the main housing comprises a plurality of axial bores; and
each one of the plurality of axial bores fluidically connects the flow channel to a one of the plurality of pressure chambers.

16. The multi-piston disengagement system of claim 11 further comprising a channel seal for sealing the flow channel, wherein the channel seal is an o-ring or a sealing plate.

17. The multi-piston disengagement system of claim 16, wherein:
the main housing or the housing cover comprises an annular groove;
the annular groove is concentric or coaxial with the main axis; and
the channel seal is the o-ring arranged in the annular groove.

18. The multi-piston disengagement system of claim 16, wherein the channel seal is the sealing plate arranged between the main housing and the housing cover.

19. The multi-piston disengagement system of claim 11, wherein the main housing and the housing cover are connected together in a form-fitting or force-fitting manner.
